(19) United States
(12) Patent Application Publication
(10) Pub. No.: US 2009/0126641 A1
(43) Pub. Date: May 21, 2009

(54) BOWL WITH OBSTRUCTIONS

(75) Inventors: Norman Anderson, Brooklyn, NY (US); Ryan Rutherford, Belleville, NJ (US); Jonathan Willinger, Tenafly, NJ (US)

Correspondence Address: KATTEN MUCHIN ROSENMAN LLP, 575 MADISON AVENUE, NEW YORK, NY, 10022-2585, US

(73) Assignee: JW PET COMPANY, INC., Teterboro, NJ (US)

(21) Appl. No.: 11/940,623

(22) Filed: Nov. 15, 2007

(51) Int. Cl. A01K 1/10

(52) U.S. Cl. 119/61.5

(57) ABSTRACT

A feeding apparatus includes an outer wall and an inner wall joined at an upper end. The inner wall includes a side wall and a bottom wall. An inner space is defined by the side wall, the bottom wall, and the upper end. One or more obstructions are provided in the inner space, each obstruction extending upright from the bottom wall and away from the sidewall. A food placement area is formed between adjacent obstructions. The rate of food consumption of an animal is reduced by the obstructions.

### BACKGROUND OF THE INVENTION

1. Field of the Invention

The present invention relates to feeding apparatus for an animal. More specifically, the present invention relates to a feeding bowl that includes one or more obstructions for reducing the rate of consumption by an animal.

2. Discussion of the Related Art

It has been alleged that bloat, i.e. gastric dilatation-volvulus (GDV), in large-breed canines or other animals is caused by the animal eating too fast. To reduce the rate of feeding, it has been suggested that obstructions or impediments be placed in a bowl, which would require the feeding animal to eat around the obstructions.

Solutions to providing a bowl with obstructions have focused on providing three rounded impediments raised upright from the bottom wall of the bowl to subdivide the food placement area. See U.S. Patent Publication 2002/0185073, U.S. Patent Publication 2006/0005774, and U.S. Patent Publication 2006/0213447, all of which are hereby incorporated by reference for all purposes.

This particular arrangement is unsatisfactory for several reasons. The impediments are situated so that the animal is unable to grab food using its jaws. Thus, the animal is forced to eat exclusively by using its tongue to bring all food into its mouth. However, by situating circular impediments away from the interior side wall, food can be pushed in an endless circle about the bowl and about the impediments by the animal's tongue.

Situating the circular impediments against the curved interior side wall creates deep and narrow pockets that trap food. If the animal is unable to remove the food, cleaning of the bowl by the animal's owner becomes an unnecessarily cumbersome chore.

Furthermore, unless animal using one of the bowls of the prior art is using a significantly oversized bowl, the animal is forced to eat exclusively by using its tongue to bring all food into its mouth. The bowls suggested by the prior art have small connected food placement areas. By design, each area limits the animal's ability to eat by taking the food with its teeth.

However, most animals, especially the large-breed canines believed to be susceptible to bloat, also eat by grabbing food with their teeth and find it frustrating to completely eat by taking food with their tongue.

The suggested bowls are also unsatisfactory because of their lack of stability by sliding over the floor.

Thus, what is desired is a bowl that obviates the unsatisfactory aspects of the prior art and permits an animal to eat more normally, and, yet, reduces the rate of consumption of the animal.

### SUMMARY OF THE INVENTION

These and other objects of the invention are met by a feeding apparatus as taught further herein.

A feeding apparatus includes an outer wall and an inner wall joined at an upper end. The inner wall includes a side wall and a bottom wall. An inner space is defined by the side wall, the bottom wall, and the upper end. One or more obstructions are provided in the inner space, each obstruction extending upright from the bottom wall and away from the sidewall. A food placement area is formed between adjacent obstructions. The rate of food consumption of an animal is reduced by the obstructions.

### BRIEF DESCRIPTION OF THE DRAWINGS

FIG. 1 is a perspective view of a feeding bowl in accordance with one or more embodiments of the present invention.

FIG. 2 is a top view of the feeding bowl of FIG. 1.

FIG. 3 is a first elevation view of a side of the feeding bowl of FIG. 1.

FIG. 4 is a second elevational view of a side of the feeding bowl of FIG. 1.

### DETAILED DESCRIPTION OF THE PREFERRED EMBODIMENTS

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, left, right, up, down, over, above, below, beneath, rear, and front may be used with respect to the drawings. These and similar directional terms should not be construed to limit the scope of the invention in any manner. The words “attach,” “connect,” “couple,” and similar terms with their inflectional morphemes do not necessarily denote direct and immediate connections, but also include connections through mediate elements or devices.

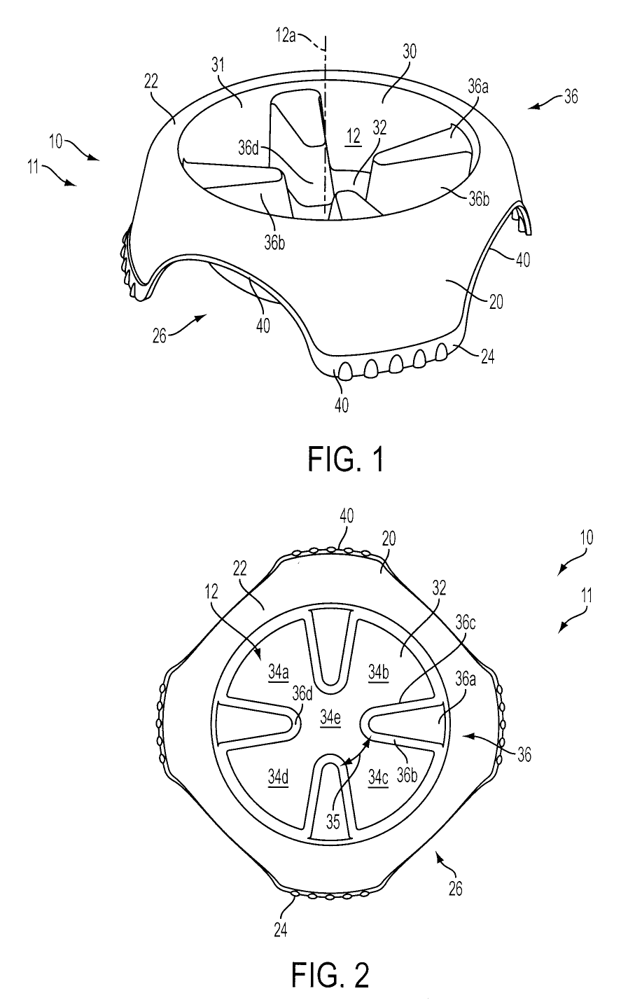

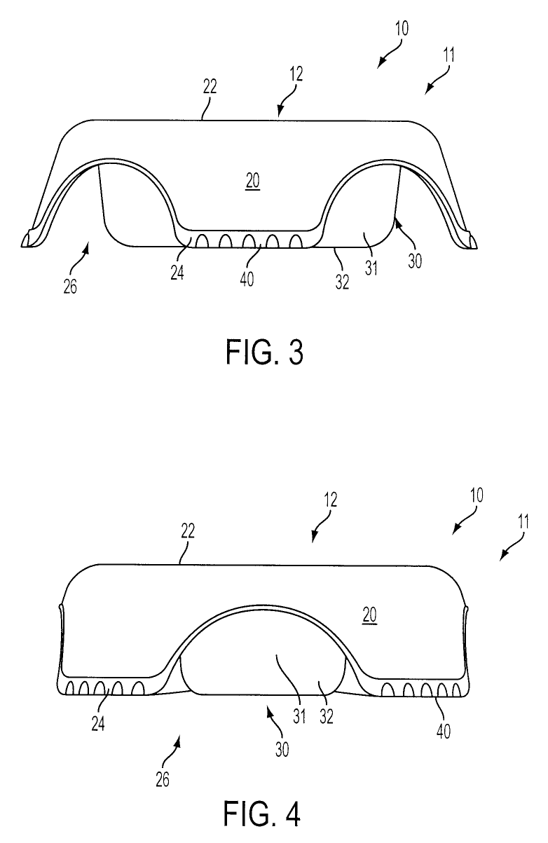

FIG. 1 is a perspective view of a feeding bowl in accordance with one or more embodiments of the present invention. FIG. 2 is a top view of the feeding bowl of FIG. 1. FIG. 3 is a first elevation view of a side of the feeding bowl of FIG. 1. FIG. 4 is a second elevational view of a side of the feeding bowl of FIG. 1.

In accordance with one or more embodiments of the present invention, with respect to FIGS. 1-4, a specialized feeding apparatus for an animal, such as a dog, is configured as a bowl 10 that may rest on support surface, which may be the ground or building floor.

The bowl includes a body 11 having an outer wall 20 and an inner wall 30 that are joined at an upper end 22. The outer wall 20 further comprises a lower end or lower rim 24 that may be positioned flared from the upper end to provide stability to bowl 10.

The inner wall 30 comprises a side wall 31 and a bottom wall 32, which preferably extending substantially along a horizontal plane that comprises one or more food placement areas 34 interrupted by the obstructions, detailed below. The food placement area may be used for receiving food, water or the like.

The body comprises an inner space 12 that is defined between the bottom wall, upper end 22, and inner wall 30.

The outer wall 20 and inner wall 30 are preferably integrally formed, for example, molded, as a one-piece structure from any suitable material, for example, a rigid plastic material such as Lexan, Acrylic, ABS, or polypropylene.

One or more openings 26 are provided in rim 24 of the outer wall for fitting an animal's paws. The opening may comprise any suitable shape, but, preferably, is arcuate to prevent sharp comers from injuring the animal.

One or more obstructions 36 are provided in the inner space 12 and extend upright from bottom wall 32 and away from side wall 31. Preferably, the obstruction is oriented outward, i.e., toward a central axis 12a of the inner space. However, if the bowl is oblong, the obstructions may be provided in the inner space 12 and extend upright from bottom wall 32 and away from side wall 31 toward an oblong central area of the inner space.

The obstructions are preferably wedge-shaped and are rounded at tips 36d to prevent injury to the animal. A top surface 36a of the obstruction is spaced from upper end 22 and is connected by flaring side walls 36b to base 36c that has a greater cross-sectional area than the top surface providing the obstruction with a taper. The taper also permits bowl 10 to be nested and/or stacked with like bowls 10 for convenient storage, shipping, and display by the consumer and/or retailer.

In a preferred embodiment; four obstructions are arranged such that they substantially divide the bowl into quarters and provide for central area sufficient for permitting an animal to use its teeth to garb food. Therein, one of the obstructions is oriented to be opposed to another of the obstructions.

Thus, food placement areas 34a-34d are formed between respective sides of the obstruction and a central food placement area 34e is formed between tips 36d of the obstructions, since the tips preferably do not extend to the center of the bowl.

The central food placement area 34e places food placement areas 34a-34d in communication with each other. The central food placement area also provides a convenient location for the user to place the food and permit it to distribute to the other food placement areas.

Each of the food placement areas 34a-34d may be substantially pie-shaped, i.e., triangular or wedge-shaped, in cross-section, and the central food placement area 34e may be approximately circular in cross-section.

Each area 34a-34d has a size that permits an animal to grab food with its teeth and to also reasonably confine the food disposed in the area. Thus, the animal is less like to push the food into another area of respective area 34a-34d.

Bowl 10 preferably comprises a size that is appropriate for an animal size as is generally known in the art, such as large bowl being appropriate for a German Shepherd Dog while a small bowl is appropriate for a Pomeranian. Accordingly, each area 34-34d may comprises a size of 12.5-22.5% of the volume of the inner space up to a level of the top surface of the obstructions and which permits an animal to grab food with its teeth.

Tips 36d of adjacent areas restrict the passage of food from respective food placement areas 34a-34d to the central food placement area 34e by limiting the width of opening 35 to ⅛ to ⅓ of the length of the food placement area along side wall 31. Advantageously, the flaring of side wall 36b increases the opening 35 from respective food placement areas 34a-34d to the central food placement area 34e which aids in distributing the food more evenly and aids in reducing consumption.

Obstructions 36 are preferably placed such that they avoid openings 26 so that the animal may conveniently stand while eating. The location of the obstructions with respect to openings 26 also provides a stable construction to the bowl.

A non-skid material 40 is preferably adhered to the bowl 10 along rim 24 and prevents displacement of the bowl. The material may be placed on the bowl according to a two material injection molding process. For example, the non-skid-material may comprise the material and method as taught in U.S. Pat. No. 6,516,747, which is hereby incorporated by reference in its entirety.

In particular, a relatively thin layer of a thermoplastic elastomer (TPE) may be over-molded onto the rim 24 of the outer wall 20 of bowl 10, which may have been made in a prior manufacturing step.

In practice, the bowl is first molded out of a conventional plastic such as Lexan, Acrylic, ABS or more commonly polypropylene. Then, the non-skid material is molded over the existing bowl. Employing this method, the resulting bond between the non-skid material and existing bowl is significantly stronger than can be obtained by manual fitting or by the use of adhesives.

In use, bowl 10 may be placed on a floor and filled with appropriate food for an animal. Since most foods, such as dry or wet dog food, will distribute by itself via gravitational flow or by lightly maneuvering the bowl in a swirling action all food placement areas may be utilized.

The non-skid material will resist movement of the bowl. The animal will be able to place its paws proximate to the bowl at the opening or in the openings 26 and eat from each food receiving area 34a-34e.

While the invention has been described in conjunction with specific embodiments, it is to be understood that many alternatives, modifications, and variations will be apparent to those skilled in the art in light of the foregoing description.

What is claimed is:

1. A feeding apparatus comprising:
an outer wall and an inner wall joined at an upper end, the inner wall comprising a side wall and a bottom wall;
an inner space defined by the side wall, the bottom wall, and the upper end;
a plurality of obstructions in the inner space, each obstruction extending upright from the bottom wall and away from the sidewall;
a food placement area being formed between adjacent obstructions;
the rate of food consumption of an animal being reduced by the obstructions.

2. The feeding apparatus of claim 1, wherein one of the plurality of obstructions may be wedge shaped.

3. The feeding apparatus of claim 2, wherein the one of the plurality of obstructions comprises a base and a top surface, the base having a greater cross-sectional area than the top surface.

4. The feeding apparatus of claim 1, wherein at least one of the plurality of obstructions is opposed to another of the plurality of obstructions.

5. The feeding apparatus of claim 1 wherein one of the plurality of obstructions comprises a flared side wall.

6. The feeding apparatus of claim 1 further comprising at least two of the plurality of obstructions comprising a tip, a central food placement area being disposed between the tips between the at least two obstructions.

7. The feeding apparatus of claim 6, wherein the food placement area formed between adjacent obstructions is in communication with the central food placement area.

8. The feeding apparatus of claim 1, wherein the food placement area is pie-shaped.

9. The feeding apparatus of claim 1 further comprising a rim in contact with a support surface, the rim comprising a non-skid material to prevent displacement.

10. The feeding apparatus of claim 1 further comprising a rim in contact with a support surface, the rim comprising an opening for accommodating a paw of the animal.

11. The feeding apparatus of claim 1, wherein the food placement area comprises a size that permits the animal to grab food with its teeth.

12. The feeding apparatus of claim 11, wherein the food placements area comprises 12.5-22.5% of the volume of the inner space up to a level of a top surface of each of the plurality of obstructions.

13. The feeding apparatus of claim 6, wherein an opening between the tips of the at least two obstructions comprises a width ⅛ to ⅓ of a length of the food placement area along the side wall associated with the inner space.

14. A feeding bowl comprising:
an injection molded body;
an inner space having a plurality of obstructions, adjacent obstructions defining respective food placement areas;
wherein the obstructions reduce the rate of consumption of food by an animal; and
wherein each of the food placement area comprises a size that permits the animal to grab food with its teeth.

15. The feeding bowl of claim 14, wherein a central food placement area is in communication with the food placement areas defined by adjacent obstructions.

16. The feeding bowl of claim 14, wherein each of the food placement areas defined by adjacent obstructions comprise 12.5-22.5% of the volume of the inner space up to a level of a top surface of each of the plurality of obstructions

17. The feeding bowl of claim 14, wherein the body is stackable.

18. The feeding bowl of claim 14 further comprising a rim in contact with a support surface, the rim comprising a non-skid material to prevent displacement.

19. The feeding bowl of claim 14 further comprising a rim in contact with a support surface, the rim comprising an opening for accommodating a paw of the animal.

20. An animal feeding bowl comprising:
a rim for resting on a support surface,
an outer wall and an inner wall joined at an upper end, the inner wall comprising a side wall and a bottom wall;
an inner space defined by the side wall, the bottom wall, and the upper end;
a plurality of obstructions in the inner space, each obstruction extending upright from the bottom wall and away from the sidewall;
a food placement area being formed between adjacent obstructions,
an opening between adjacent obstructions placing the food placement areas in communication with a central food placement area,
wherein the rate of food consumption of an animal is reduced by the obstructions.
